(19) United States
(12) Patent Application Publication
(10) Pub. No.: US 2006/0015622 A1
(43) Pub. Date: Jan. 19, 2006

(54) Enabling asynchronous transaction interactions on Web browsers

(75) Inventors: Satish Gungabeesoon, Markham (CA); Michael John Hickman, Rochester, MN (US); Jiayun Zhu, North York (CA)

Correspondence Address: IBM Corporation;IP Law Dept. T81, Bldg. 503, 3039 Cornwallis Road, P.O. Box 12195, Research Triangle Park, NC, 27709, US

(73) Assignee: International Business Machines Corporation, Armonk, NY (US)

(21) Appl. No.: 10/890,768

(22) Filed: Jul. 14, 2004

(51) Int. Cl. G06F 15/16

(52) U.S. Cl. 709/227

(57) ABSTRACT

A method, apparatus, and computer instructions in a data processing system for enabling asynchronous transaction interactions. A Web page containing transaction data is sent to a client, wherein the Web page includes a process to periodically submit a timeout notification. Program logic is executed after sending the Web page to the client. In response to an event during execution of the program logic, it is determined whether user data input into the Web page at the client is available at the data processing system. In response to user data being present, the user data is processed, wherein asynchronous processing of transactions occur between the data processing system and the client.

### BACKGROUND OF THE INVENTION

1. Technical Field

The present invention relates generally to an improved data processing system and in particular, to a method and apparatus for processing data. Still more particularly, the present invention relates to a method, apparatus, and computer instructions for enabling asynchronous transaction interactions on Web browsers.

2. Description of Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized both communications and commerce, as well as, being a source of both information and entertainment. For many users, email is a widely used format to communicate over the Internet. Additionally, the Internet also is used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML also are referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content.

The browser includes a user interface, which is a GUI that allows the user to interface or communicate with another browser. This interface provides for selection of various functions through menus and allows for navigation. For example, a menu may allow a user to perform various functions, such as saving a file, opening a new window, displaying a history, and entering a URL.

Through this interface provided by a browser, interactions between the browser and an application running on a Web application server may occur. These interactions may be used to transfer data and facilitate processing of information. Currently, interactions between a browser and a server are based on an ordered sequence of transaction request and reply pairs. In other words, the user at a browser may request a Web page from a server. The Web page is delivered to the browser from the server. In response, the user may input data. When data input has completed, the user executes a command to submit the data. The application at the server processes the data when the data is submitted by the user to the server process. These sequences of requests and replies form a synchronous set of transactions. The application at the server is required to wait for the data prior to performing additional processing.

Such a process for transactions is inefficient with respect to processing at the server. The server application is required to remain idle with respect to a particular client until data is received. Therefore, it would be advantageous to have an improved, method, apparatus, and computer instructions for enabling asynchronous transactions in processing data input into a browser.

### BRIEF SUMMARY OF THE INVENTION

The present invention provides a method, apparatus, and computer instructions in a data processing system for enabling asynchronous transaction interactions. A Web page containing transaction data is sent to a client. The Web page includes a process to periodically submit a timeout notification if user data has not been submitted within a predefined time period. Program logic is executed after sending the Web page to the client. In response to an event during execution of the program logic, a determination is made as to whether user data input into the Web page at the client is available at the data processing system. In response to user data being present, the user data is processed. Otherwise, new transaction data may be sent to the browser, and/or execution of program logic is resumed, wherein asynchronous processing of transactions occurs between the data processing system and the client.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram used for enabling asynchronous transaction interactions on a Web browser in accordance with a preferred embodiment of the present invention;

FIGS. 5A-5C are diagrams illustrating screens in accordance with a preferred embodiment of the present invention;

FIG. 6 is a flowchart of a process for asynchronous transaction processing in accordance with a preferred embodiment of the present invention;

FIG. 7 is a flowchart of a timeout process in accordance with a preferred embodiment of the present invention;

FIG. 8 is a diagram of hypertext markup language (HTML) for a Web page used as a screen in accordance with a preferred embodiment of the present invention;

FIG. 9 is a code for a timeout process in accordance with a preferred embodiment of the present invention; and

FIG. 10 is a diagram of HTML code for a generic application in accordance with a preferred embodiment of the present invention.

### DETAILED DESCRIPTION OF THE INVENTION

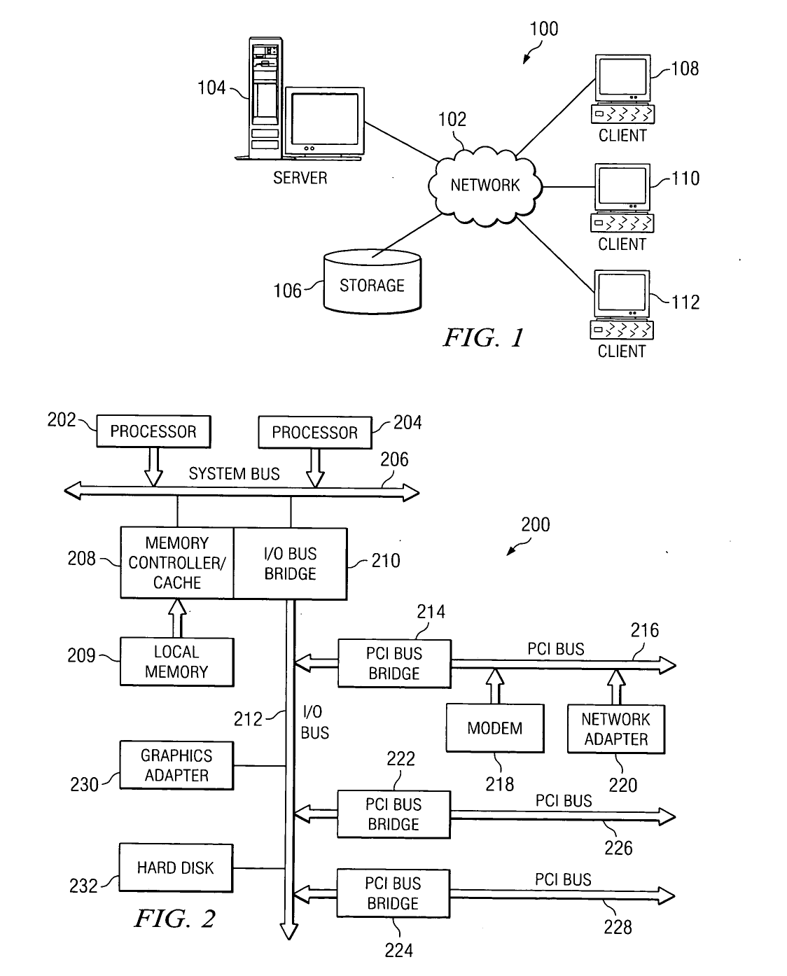

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. In these examples, data processing system 200 may host or execute server processes, such as a server program or application used to facilitate transactions with browsers on client data processing systems.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

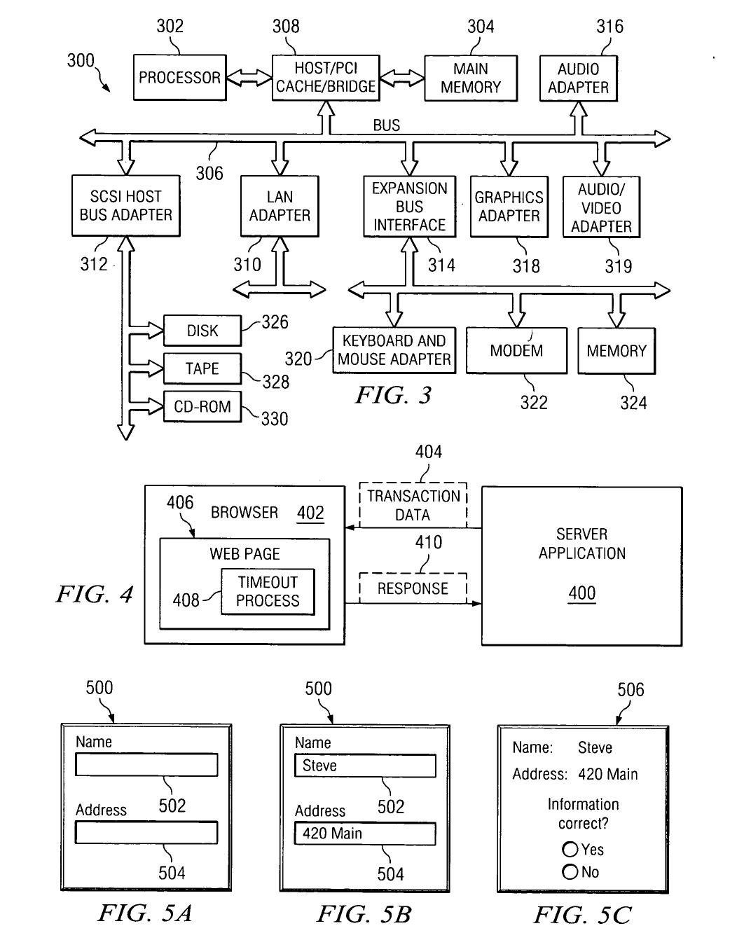

With reference now to FIG. 3, a block diagram illustrating a data processing system is depicted in which the present invention may be implemented. Data processing system 300 is an example of a client computer. In the illustrative embodiments, data processing system 300 executes a browser, which interacts with server applications on a server data processing system.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent non-volatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention recognizes that legacy applications on systems provide support for broadcasting screen I/O to multiple display terminals, with the ability to overwrite the displayed screens with new business transaction data after a certain amount of time has expired. These legacy applications are typically located on a mainframe computer that transmits screens to a dumb terminal for display to a user. This technique for displaying screens allows users a defined amount of time to enter transaction data. This feature also is called “inviting the device”.

When a display terminal is invited, the application performing the screen I/O can continue executing program logic while the user enters data at the display terminal. The two operations take place independent of each other in an asynchronous mode. After a certain amount of time, the application may request the user entered data or may overwrite the displayed screen with new transaction data if no transaction data has yet been submitted by the user.

The present invention recognizes that supporting similar capabilities when the display terminal is replaced by a browser brings up certain challenges since communications to a browser is based on an ordered sequence of requests/replies pairs between the browser and the web server, while the above scenario requires the use of unpaired replies from the Web server. The present invention discloses a mechanism to allow Web applications to perform asynchronous transaction processing giving the web application the same capability that legacy applications have.

More specifically, the present invention provides an improved method, apparatus, and computer instructions for enabling asynchronous transaction interactions on a browser. The mechanism of the present invention employs a timer process that generates a notification that is returned to a server application. This timer process is implemented within a Web page that is sent to the browser. In the illustrative examples, this process is implemented using JavaScript. In generating the notification, user data entered in the Web page may be returned. In this manner, a server application does not need to wait for a user to submit data and may continue to perform or execute program logic while waiting for user data to become available. As used in these examples, program logic is a set of computer instructions within or associated with the server application. These computer instructions may be, for example, a module, a subroutine, or a process.

Turning next to FIG. 4, a block diagram used for enabling asynchronous transaction interactions on a Web browser is depicted in accordance with a preferred embodiment of the present invention. In the illustrative example, server application 400 is an application running on a server data processing system, such as data processing system 200 in FIG. 2. Browser 402 is a browser running on a client data processing system, such as data processing system 300 in FIG. 3.

Server application 400 sends transaction data 404 to browser 402. Transaction data 404 takes the form of Web page 406, which is displayed in browser 402. This data is typically sent in response to a user request, such as the entry of a URL or the selection of a link or button on a Web page. In the illustrative examples, Web page 406 contains an interface for receiving user data. In these examples, this user data is any information that will be entered by a user, such as, name and address information. Additionally, other information, such as product numbers, prices, telephone numbers, email addresses, and answers to questions, may be entered to form user data.

Previously, server application 400 only received user data when the user submitted the data for processing. The mechanism of the present invention includes a timer mechanism, such as timeout process 408, to push or send user data back to server application 400 in response 410. With this mechanism, browser 402 is decoupled from a transaction request and reply pair constraint. Server application 400 may push transaction data to browser 402 based on the processing of any available user data that has been entered into Web page 406. Also, additional transaction data may be pushed to browser 402 in response to an absence of user data being available when timeout process 408 returns response 410 to server application 400.

With this mechanism, program logic processes server application 400 may run independently of browser 402, while a user interacts with Web page 406. Browser 402 sends any user data entered in Web page 406 back to server application 400 after a defined period of time. These features allow server application 402 to process transactions independently of the state of browser 402 and refresh the display of transaction data in browser 402. As used herein, a transaction data takes the form of a screen, such as Web page, sent to a browser or user data that is returned to a server application.

Turning next to FIGS. 5A-5C, diagrams illustrating screens are depicted in accordance with a preferred embodiment of the present invention. In these examples, the screens take the form of Web pages displayed on a browser, such as browser 402 in FIG. 4. Each of these screens contains a timeout process 408 in FIG. 4.

In this illustrative example, screen 500 in FIG. 5A is the first screen displayed by the browser. This screen includes name field 502 and address field 504. These fields are designed to receive user data. In FIG. 5B, screen 500 contains data in name field 502 and address field 504. If the timer expires, the data entered in these fields are returned to the server application without requiring user input to submit the data. If the user has entered no data in screen 500, no user data is available. In FIG. 5B, a name and a portion of an address is returned as the user data.

In response to only a portion of the address being entered, the server application may return screen 500 to the browser with the user data entered so far so that the user may complete entry of the data. With the user data entered so far by user, the server application may begin processing of the user data. If sufficient user data is entered, a different screen, such as screen 506 in FIG. 5C may be returned for display. Screen 506 asks the user to verify whether the entered information is correct. In this manner, the server application may begin processing data already entered without having to wait for a user to submit the data. Thus, this mechanism allows the collection of information and interaction that is currently present with legacy applications.

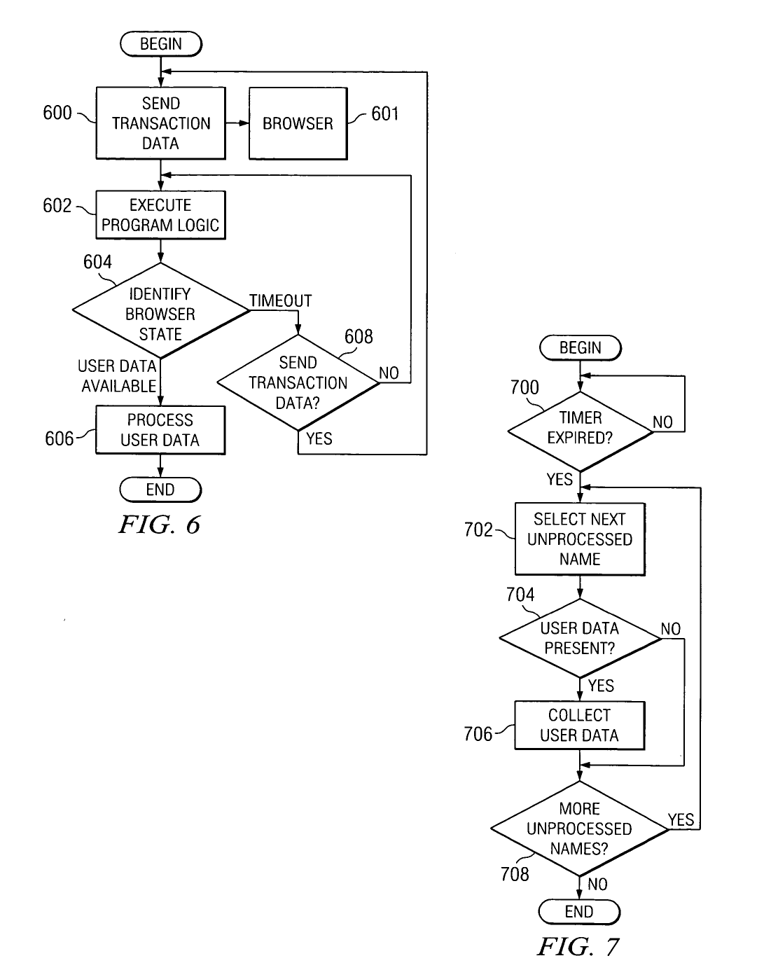

With reference now to FIG. 6, a flowchart of a process for asynchronous transaction processing is depicted in accordance with a preferred embodiment of the present invention. The process illustrated in FIG. 6 may be implemented in a server, such as server application 400 in FIG. 4.

The process begins by sending transaction data to the browser on a client (step 600). The transaction data in step 600 is a Web page for entering user data. This Web page also includes a timer, such as timeout process 408 in FIG. 4. The transaction data is sent to browser 601. Program logic is then executed (step 602). This program logic executes while waiting for user data to become available. After some period of time, the browser state is identified (step 604). In addition to using a period of time, the browser state may be identified in response to an event.

If user data is available, the user data is then processed (step 606) with the process terminating thereafter. This processing of data may include reinitiating the process illustrated in FIG. 6 or other processing of user data. This data processing may include, for example, analyzing the user data, storing the user data, or sending additional transactions to the browser.

With reference again to step 604, if a timeout has been identified for the browser state, a determination is made as to whether additional transaction data is to be sent (step 608). If additional transaction data is to be sent, the process returns to step 600. This additional transaction data, may be, sending a Web page for a different screen to the browser. Otherwise, the process returns to step 602 to continue execution of the program logic.

With reference now to FIG. 7, a flowchart of a timeout process is depicted in accordance with a preferred embodiment of the present invention. The process illustrated in FIG. 7 may be implemented in a timer, such as timeout process 408 in FIG. 4.

The process begins by determining whether a timer has expired (step 700). The process returns to step 700 until the timer expires. Expiration of the timer is determined by attempting to retrieve the timer name. If a time name is not present in the array of name and value pairs, a timeout has not yet occurred. In this case, the user has submitted user input data. Upon the timer expiring, a timer name and value pair are retrieved. This information is used to indicate that a timeout has occurred. For example, the name may be “timeout value” with the value being “yes”.

Next, the next unprocessed name for a field is selected (step 702). The name and value pairs in step 702 are delivered to the server in an array. In these illustrative examples, the different Web pages sent for display have a standard set or predefined set of names for the fields in which user data is received. This process determines whether data is present for different names and collects the data. A determination is made as to whether user data is present in the selected field (step 704). If user data is present, the user data is collected (step 706). Thereafter, a determination is made as to whether additional unprocessed names are present (step 708). If additional unprocessed names are present, the process returns to step 702 to select another unprocessed name. Otherwise, the process terminates. With reference again to step 704, if user data is not present, the process proceeds directly to step 708 as described above.

The automatic submission of a timeout event is based on implementing a timer in the Web pages delivered to the browser. In the illustrative examples, a timer is coded in the Web page by using a JavaScript method. For example, window.setTimeout (“timeout( )”, initialvalue) is included in the onload handler of the page. The timer starts when the Web page is loaded in the browser. The constant initialvalue sets the initial value of the timer.

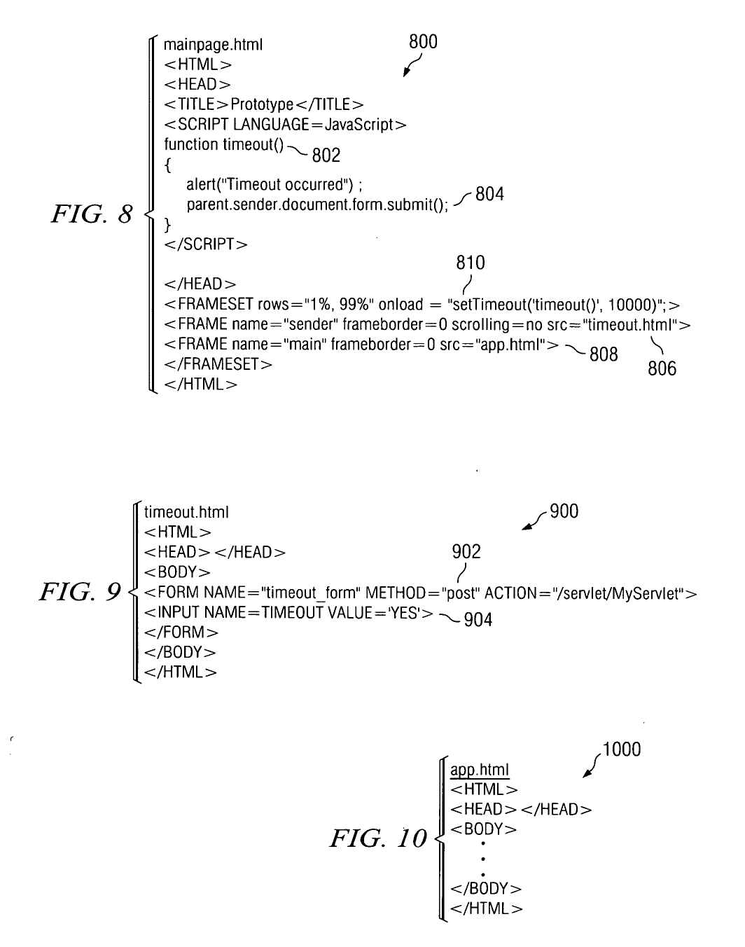

The method timeout( ) receives control when the timer expires. The function of this method is to programmatically submit a timeout indicator back to the server by executing the following JavaScript instructions associated with a form document.writeln(“<INPUT NAME=TIMEOUT VALUE=‘YES’>”);document.form.submit( ). The server is notified of the occurrence of a timeout by reading the TIMEOUT parameter in the received form data. FIGS. 8-10 illustrate example code for these features.

With reference now to FIG. 8, a diagram of hypertext markup language (HTML) for a Web page used as a screen is depicted in accordance with a preferred embodiment of the present invention. Code 800 includes a call to a JavaScript function in line 802. In this example, the function sends a document back to the server application in line 804. This information includes a name and value pair used to indicate that a timeout has occurred. Additionally, this document also may include any user data entered by the user into the Web page.

Code 800 contains two frames, one for the timer or the timeout process and another for the main application used to display the screen to a user. The timeout process is illustrated in FIG. 9, while the application is illustrated in FIG. 10. Line 806 identifies the timeout process for one frame, while 808 defines the application for another frame. Line 810 is used to define frame sizes for these two frames. The frame size for a timeout process may be sized such that the timeout process is invisible when the Web page is displayed. Additionally, the timeout value is set to 10,000 milliseconds or 10 seconds.

With reference now to FIG. 9, code for a timeout process is depicted in accordance with a preferred embodiment of the present invention. In this example, code 900 identifies a method in line 902, which is to post information to a target server process called MyServlet located in directory servlet. Line 904 in code 900 contains the name and value pair for the value that is sent back to the server to allow the server to read the state of the browser.

Turning next to FIG. 10, a diagram of HTML code for application is depicted in accordance with a preferred embodiment of the present invention. Code 1000 is example of a shell that may contain code for a generic application to display a screen to the user.

Thus, the present invention provides an improved method, apparatus, and computer instructions for enabling asynchronous transactions between a browser and a server. This type of processing is similar to that provided by legacy applications sending transaction data for display on screens of dumb terminals. The mechanism of the present invention employs a timer process to notify a timeout event to the server application and initiate the transfer of data to a server application on a periodic basis. If the user input data is not available, only a timeout notification is sent to the server application. This transfer of data allows the server application to process user data without requiring the currently synchronous system in which the user is required to submit the data before data can be processed by the server application.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for enabling asynchronous transaction interactions, the method comprising:
sending a Web page containing transaction data to a browser at a client, wherein the Web page includes a process to periodically submit a timeout notification;
executing a program logic in a server application asynchronously with the browser after sending the Web page to the browser at the client;
responsive to an event during execution of the program logic, determining whether user data input into the Web page at the client is available at the data processing system; and
responsive to user the data being present, processing the user data, wherein asynchronous processing of transactions occurs between the data processing system and the client.

2. The method of claim 1 further comprising:
responsive to the user data being absent, sending new transaction data in a new Web page to the client.

3. The method of claim 1 further comprising:
responsive to the user data being absent, continuing to execute the program logic.

4. The method of claim 1, wherein the user data is submitted with the timeout notification.

5. The method of claim 1, wherein the event is a periodic event.

6. The method of claim 1, wherein the event is a non periodic event.

7. The method of claim 1, wherein the non periodic event is an execution of a selected instruction in the program logic.

8. The method of claim 1, wherein the processing step comprises:
determining whether sufficient user data is present;
responsive to the sufficient user data being present, processing the user data; and
responsive to the insufficient user data being present, sending the transaction data in a second Web page to the client.

9. The method of claim 1, wherein the processing step comprises:
sending a second Web page containing additional transactional data to the client, wherein the second Web page includes the process to periodically submit the timeout notification.

10. A method in a data processing system for asynchronously transferring data, the method comprising:
receiving a Web page from a server, wherein the Web page includes a process for periodically submitting a timeout notification;
responsive to detecting a timeout for the process, collecting any user data entered into the Web page to form available user data; and
sending the timeout notification with the available user data to the server.

11. A data processing system for enabling asynchronous transaction interactions, the data processing system comprising:
sending means for sending a Web page containing transaction data to browser at a client, wherein the Web page includes a process to periodically submit a timeout notification;
executing means for executing a program logic in a server application asynchronously after sending the Web page to the browser at the client;
determining means, responsive to an event during execution of the program logic, for determining whether user data input into the Web page at the client is available at the data processing system; and
processing means, responsive to user the data being present, for processing the user data, wherein asynchronous processing of transactions occurs between the data processing system and the client.

12. The data processing system of claim 11, wherein the sending means is a first sending means and further comprising:
second sending means, responsive to the user data being absent, for sending new transaction data in a new Web page to the client.

13. The data processing system of claim 11 further comprising:
continuing means, responsive to the user data being absent, for continuing to execute the program logic.

14. The data processing system of claim 11, wherein the user data is submitted with the timeout notification.

15. The data processing system of claim 11, wherein the event is a periodic event.

16. The data processing system of claim 11, wherein the event is a non periodic event.

17. The data processing system of claim 11, wherein the non periodic event is an execution of a selected instruction in the program logic.

18. The data processing system of claim 11, wherein the processing means comprises:
determining means for determining whether sufficient user data is present;
sub-processing means, responsive to the sufficient user data being present, for processing the user data; and
means, responsive to the insufficient user data being present, for sending the transaction data in a second Web page to the client.

19. The data processing system of claim 11, wherein the processing means comprises:
means for sending a second Web page containing additional transactional data to the client, wherein the second Web page includes the process to periodically submit the timeout notification.

20. A data processing system for asynchronously transferring data, the data processing system comprising:
receiving means for receiving a Web page from a server, wherein the Web page includes a process for periodically submitting a timeout notification;
collecting means, responsive to detecting a timeout for the process, for collecting any user data entered into the Web page to form available user data; and
sending means for sending the timeout notification with the available user data to the server.

21. A computer program product in a computer readable medium for enabling asynchronous transaction interactions, the computer program product comprising:
first instructions for sending a Web page containing transaction data to a browser at a client, wherein the Web page includes a process to periodically submit a timeout notification;
second instructions for executing a program logic in a server application asynchronously with the browser after sending the Web page to the browser at the client;
third instructions, responsive to an event during execution of the program logic, for determining whether user data input into the Web page at the client is available at the data processing system; and
fourth instructions, responsive to user the data being present, for processing the user data, wherein asynchronous processing of transactions occurs between the data processing system and the client.

22. The computer program product of claim 21 further comprising:
fifth instructions responsive to the user data being absent, for sending new transaction data in a new Web page to the client.

23. The computer program product of claim 21 further comprising:
fifth instructions, responsive to the user data being absent, for continuing to execute the program logic.

24. The computer program product of claim 21, wherein the user data is submitted with the timeout notification.

25. The computer program product of claim 21, wherein the event is a periodic event.

26. The computer program product of claim 21, wherein the event is a non periodic event.

27. The computer program product of claim 21, wherein the non periodic event is an execution of a selected instruction in the program logic.

28. The computer program product of claim 21, wherein the fourth instructions comprises:
first sub-instructions for determining whether sufficient user data is present;
second sub-instructions, responsive to the sufficient user data being present, for processing the user data; and
third sub-instructions, responsive to the insufficient user data being present, for sending the transaction data in a second Web page to the client.

29. The computer program product of claim 21, wherein the fourth instructions comprises:
first sub-instructions for sending a second Web page containing additional transactional data to the client, wherein the second Web page includes the process to periodically submit the timeout notification.

30. A computer program product in a computer readable medium for asynchronously transferring data, the computer program product comprising:
first instructions for receiving a Web page from a server, wherein the Web page includes a process for periodically submitting a timeout notification;
second instructions, responsive to detecting a timeout for the process, for collecting any user data entered into the Web page to form available user data; and
third instructions for sending the timeout notification with the available user data to the server.

31. A data processing system comprising:
a bus system;
a memory connected to the bus system, wherein the memory includes a set of instructions; and
a processing unit connected to the bus system, wherein the processing unit executes a set of instructions to send a Web page containing transaction data to a client, wherein the Web page includes a process to periodically submit a timeout notification; execute a program logic after sending the Web page to the client; determine whether user data input into the Web page at the client is available at the data processing system in response to an event during execution of the program logic; and process the user data, wherein asynchronous processing of transactions occurs between the data processing system and the client in response to the user data being present.

32. A data processing system comprising:
a bus system;
a memory connected to the bus system, wherein the memory includes a set of instructions; and
a processing unit connected to the bus system, wherein the processing unit executes a set of instructions to receive a Web page from a server, wherein the Web page includes a process for periodically submitting a timeout notification; collect any user data entered into the Web page to form available user data in response to detecting a timeout for the process; and send the timeout notification with the available user data to the server.
